(19) United States
(12) Patent Application Publication
(10) Pub. No.: US 2015/0327647 A1
(43) Pub. Date: Nov. 19, 2015

(54) ILLUMINATED BAG

(71) Applicant: Brian Wiklacz, Simpsonville, SC (US)

(72) Inventor: Brian Wiklacz, Simpsonville, SC (US)

(21) Appl. No.: 14/712,424

(22) Filed: May 14, 2015

Related U.S. Application Data
(60) Provisional application No. 61/993,047, filed on May 14, 2014.

(51) Int. Cl. A45C 15/06; F21V 23/04; F21V 7/22; F21V 33/00

(52) U.S. Cl. CPC A45C 15/06; F21V 33/0004; F21V 23/04; F21V 7/22; F21Y 2101/02

(57) ABSTRACT

An illuminated bag, such as a tote bag is provided. The illuminated bag includes a sidewall forming the bag, and including an upper rim forming an entrance into the bag. The sidewall is made of a translucent material. A light device is attached to the sidewall. The light device includes a power source, switch and a light. The light device is secured to the illuminated bag so that the light is directed towards an inner surface of the sidewall thereby illuminating the inside and surroundings of the bag.

### CROSS-REFERENCE TO RELATED APPLICATION

This application claims the benefit of priority of U.S. provisional application No. 61/993,047, filed May 14, 2014, the contents of which are herein incorporated by reference.

### BACKGROUND OF THE INVENTION

The present invention relates to trick-or-treating bags and, more particularly, to an illuminated bag.

Trick-or-treating is a customary practice for children on Halloween in many countries. Children in costumes travel from house to house in order to ask for treats such as candy (or, in some cultures, money) with the phrase “Trick or treat!” Trick-or-treating typically happens at dusk and at night. In low light and dark environments it is difficult to collect, dispense, store and carry items, such as Halloween treats, while simultaneously: 1) being visible to others, especially motor vehicle operators; 2) having visibility of the items being collected; 3) having visibility of the location to dispense the items; and 4) having visibility of surroundings.

As can be seen, there is a need for an illuminated bag for trick-or-treating.

### SUMMARY OF THE INVENTION

In one aspect of the present invention, an illuminated bag comprises: a sidewall forming a bag comprising an upper rim forming an entrance into the bag, wherein the sidewall comprises a translucent material; and a light device comprising a power source and a light, the light device attached to the sidewall so that the light is directed towards an inner surface of the sidewall.

These and other features, aspects and advantages of the present invention will become better understood with reference to the following drawings, description and claims.

### BRIEF DESCRIPTION OF THE DRAWINGS

FIG. 1 is a perspective view of the present invention, shown with a light illuminating the bag and the contents;

FIG. 2 is a front perspective view of the present invention;

FIG. 3 is a rear perspective view of the present invention;

FIG. 4 is an exploded view of the present invention; and

FIG. 5 is a section view of the present invention, taken along line 5-5 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a translucent, illuminated tote bag for use in low-light and dark environments that simultaneously illuminates, the user, the user's surroundings, the bag's interior, the bag's exterior and images/patterns on the bag's surface.

The present invention includes a tote bag made of translucent fabric, a battery operated LED light affixed to the top perimeter of the tote bag, an image/pattern on the tote bag and reflective stitching on the tote bag. These components work together as a system to make the tote bag user visible to others, especially motor vehicle operators and make the items collected, stored and carried in the bag visible to the user. These components working together also make the bag's opening visible to the people dispensing items to the user. Additionally, the components of the present invention allow the user to see their surroundings as well as making the image(s)/pattern(s) on the translucent fabric visible in luminary and silhouette fashion. In addition the reflective stitching/material enhances visibility of the bag, especially to motor vehicle operators.

The present invention includes a battery operated LED Light that illuminates the interior of the bag. It has a two part circular casing. When separated one part of the casing can be inserted into the bag through hole, penetrating the opposite side. The other part of the casing clips over the protrusion, thus securely fastening the LED light to the bag. The translucent fabric allows light from the interior of the bag to shine through to the exterior of the bag, illuminating both the exterior surface of the bag and the image(s)/pattern(s) on the surface of the bag. The image/pattern overlay or printed image/pattern may be sewn or printed on the translucent fabric. It is visible when the bag is lit, in luminary and/or silhouette fashion, depending on the translucency or opacity of the image. The bag through hole facilitates the quick, easy and secure attachment of the LED light, enabling the light to shine outward, away from the bags outer surface, upward towards the user, as well as inward, into the bags interior. The bag through hole may be reinforced with a grommet, stitching or additional material or various combinations of the three. In addition to the illumination from the battery operated light, the reflective stitching enhances visibility of the bag, especially to motor vehicle operators. Additionally, the stitching accentuates/outlines the bag, the bag image(s) and the bag handles.

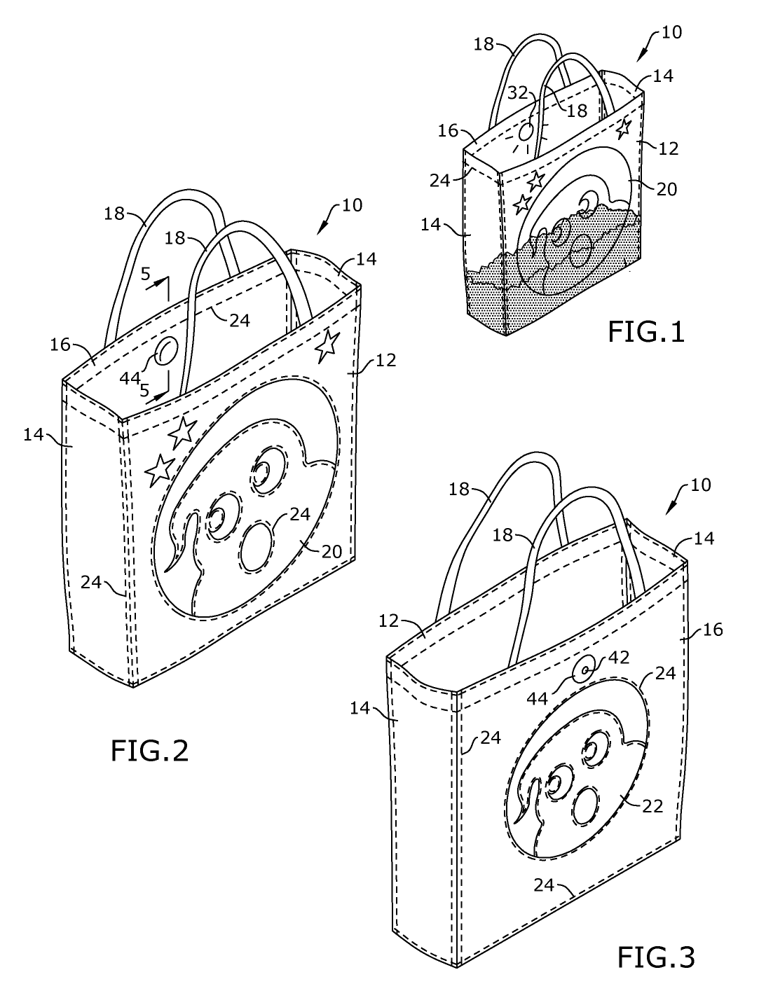

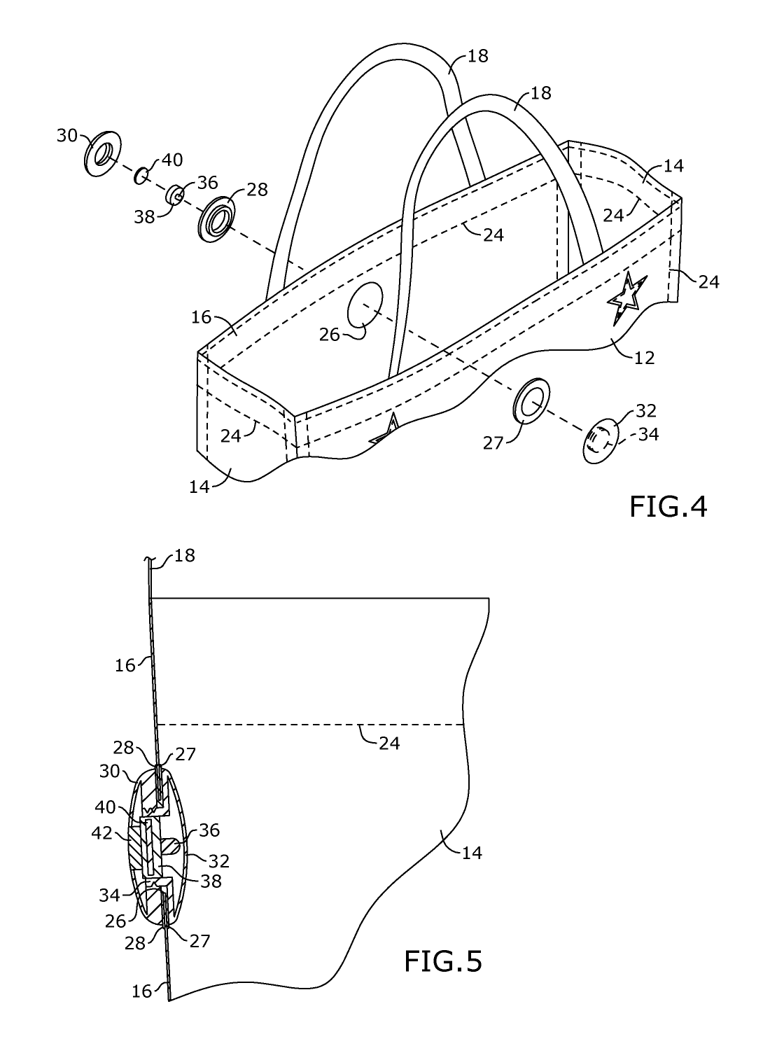

Referring to FIGS. 1 through 5, the present invention includes an illuminated bag 10, such as a tote bag. The illuminated bag 10 includes a sidewall 12, 14, 16 forming the bag, and including an upper rim forming an entrance into the bag. The sidewall 12, 14, 16 is made of a translucent material. A light device 44 is attached to the sidewall 12, 14, 16. The light device 44 includes a power source 40, switch 42 and a light 36. The light device 44 is secured to the illuminated bag 10 so that the light 36 is directed towards an inner surface of the sidewall 12, 14, 16, thereby illuminating the inside and surroundings of the bag.

In certain embodiments, the sidewall 12, 14, 16 of the present invention includes a front panel 12, a rear panel 16 opposite the front panel 12, and two side panels 14 each connecting the front panel 12 and the rear panel 16. A pair of handles 18 may be attached to the front panel 12 and the rear panel 16 and extend from the upper rim. The present invention may include a design 20 formed on the front panel 12 and a design 22 formed on the rear panel 16. The design 20, 22 may be stitched or printed onto the surface of the sidewall 12, 14, 16. Since the sidewall 12, 14, 16 is translucent, the design 20, 22 may be highlighted and easily viewable due to the light 36.

The front panel 12, the rear panel 16 and the side panels 14 may be stitched together by a stitching 24. In certain embodiments, the stitching 24 may be made of a reflective material. Therefore, the light directed towards the stitching 24 may be reflected and thereby magnified. In certain embodiments, the designs 20, 22 may be formed by the reflective stitching 24, thereby magnifying the visibility of the design 20, 22.

In certain embodiments, a through hole 26 may be formed through the sidewall 12, 14, 16. The light device 44 is attachable to the sidewall 12, 14, 16 via the through hole 26. In certain embodiments, the through hole 26 may be formed through one of the front panels 12, the rear panels 16 and side panels 14 near the upper edge. A grommet 27, 28 may be secured to the sidewall 12, 14, 16 via the through hole 26. The grommet 27, 28 may include a front 27 and a back 28 that snap together.

The light device 44 may further include a housing having a back casing 30 and a translucent front casing 32. The back casing 30 is attachable to the front casing 32 via a threaded rod 34 of the front casing 32 securable within a threaded receiver of the back casing 30. The light 36, such as a light emitting diode, and the power source 40, such as a battery, are secured within the housing 30, 32. Internal edges of the housing 30, 32 may clamp against the grommet 27, 28, or through hole 26, without grommet, thereby securing the light device 44 to the sidewall 12, 14, 16. The light device 44 may further include a push button 42 to control the output of the power source 40 to the light 36, thereby turning the light 36 on and off.

A method of making the present invention may include the following. The tote bag may be constructed out of a single layer of flame retardant, translucent fabric. The initial bag construction may be rectangular in nature having a rectangular front and back of equal measure, two corresponding rectangular sides of equal measure and a corresponding rectangular bottom. In addition to the single layer of translucent fabric, one or more surfaces of the bag may be constructed with images/patterns. These images/patterns may either be made of complementing flame retardant fabric/material sewn onto the surface of the bag or printed directly on the surface of the bag. Reflective stitching may be used at the bag seams and to outline the image overlays. The top perimeter of the bag may be constructed as to provide some stiffness or rigidity to the perimeter such that opposite surfaces of the bag remain separated when the bag is empty. Creating a hem with a multiple fold over or sewing a stiffening material into the hem or a combination of the two may be used to accomplish this stiffening. A through hole may be cut into one of vertical surfaces of the bag slightly below the top perimeter hem and centered horizontally in the surface. The through hole may be reinforced with a grommet, stitching or additional material or combinations of one or more of these items. The finished thru-hole may have a specified inside diameter, outside diameter and thickness to accommodate the pre-manufactured battery operated LED. Upon the completion of the bag construction the pre-manufactured battery operated LED is be affixed to the bag. The LED two part casing may separate and the male portion of the casing may be inserted into the bag through hole from the inside surface, until it penetrates the outside surface. The female portion of the casing may then be clipped over the protrusion on the outside surface creating a clamping force that securely fastens the LED light to the bag.

A person may use the present invention in low-light and dark environments to achieve the maximum benefits. The present invention may be used to collect, store and carry items, such as Halloween treats in a fun, attractive and safe way. With a single click of the LED switch, the bag, the user, the items collected by user, the location to dispense items to the user, the user's surroundings and the decorative images on the bag's surface are visible in low-light and dark environments. With this functionality, the user may use the bag to be visible in the dark, especially to motor vehicle operators. The user may also use the bag to see the items being collected and stored in the bag, such as Halloween treats. Additionally, the user may use the bag to provide treat givers better visibility of where to dispense their treats. The user may also use the bag to increase visibility of his/her surroundings to see their way in the dark and may also use the bag to display a unique decorative image/pattern on the bag's surface. The user may also use the bag to further enhance visibility of themselves to motor vehicle operators via the bag's reflective stitching/material. When collecting and storing items in the bag, the user fills the bag at a maximum level just below the bottom of the battery operated LED light to maintain the maximum benefits of the present invention. The present invention may be used for Halloween trick-or-treating but may also be used for Independence Day, Camp outings, Christmas, Valentine's Day, St Patrick's Day, Charity Events, and the like.

It should be understood, of course, that the foregoing relates to exemplary embodiments of the invention and that modifications may be made without departing from the spirit and scope of the invention as set forth in the following claims.

What is claimed is:

1. An illuminated bag comprising:
a sidewall forming a bag comprising an upper rim forming an entrance into the bag, wherein the sidewall comprises a translucent material; and
a light device comprising a power source and a light, the light device attached to the sidewall so that the light is directed towards an inner surface of the sidewall.

2. The illuminated bag of claim 1, further comprising a grommet secured within an opening through the sidewall, wherein the light device is removably attachable to the grommet.

3. The illuminated bag of claim 2, wherein the light device further comprises a housing comprising a back casing releasably attachable to a translucent front casing, wherein the light and the power source are secured within the housing.

4. The illuminated bag of claim 1, wherein the light device further comprises a push button to control the output of the power source to the light.

5. The illuminated bag of claim 1, wherein the light is a light emitting diode.

6. The illuminated bag of claim 1, wherein the sidewall comprises a front panel, a rear panel opposite the front panel, and two side panels connecting the front panel and the rear panel.

7. The illuminated bag of claim 6, further comprising a design formed on the sidewall.

8. The illuminated bag of claim 6, wherein the panels are connected by a stitching comprising a reflective material.

9. The illuminated bag of claim 7, wherein the design is printed or stitched onto the sidewall.

10. The illuminated bag of claim 1, further comprising handles extending from the upper rim of the sidewall.
